(19) United States
(12) Patent Application Publication
(10) Pub. No.: US 2003/0101279 A1
(43) Pub. Date: May 29, 2003

(54) Method for transferring messages along optimally redundant network paths in a distributed communication network

(76) Inventor: Rajiv Maheshwari, Sunnyvale, CA (US)

Correspondence Address: Mr. Rajiv Maheshwari, SLAM DUNK NETWORKS, INC., 100 Redwood Shores Parkway, Suite 100, Redwood City, CA, 94065, US

(21) Appl. No.: 09/997,839

(22) Filed: Nov. 29, 2001

(51) Int. Cl. G06F 15/173

(52) U.S. Cl. 709/241

(57) ABSTRACT

A method that provides for the reliable and timely transfer of messages on a distributed communication network includes choosing a plurality of candidate overlay route processors from the distributed communication network, the candidate overlay route processors being coupled to a message source and a message destination of the network. Thereafter, the identity of intervening network components in the network paths between the message source and each of the candidate overlay route processors is ascertained. Next, at least two selected overlay route processors are selected from the candidate overlay route processors based on minimizing the number of overlapping intervening network components in the network paths between the message source and the at least two selected overlay route processors. A message is the transferred from the message source to the at least two selected overlay route processors along the network paths with a minimized number of overlapping intervening network components.

### BACKGROUND OF THE INVENTION

1. Field of the Invention

The present invention relates, in general, to methods for the reliable and timely transfer of messages in a distributed communication network and, in particular, to a method for transferring messages along optimally redundant network paths.

2. Description of the Related Art

The successful and efficient electronic transfer of messages (e.g., business information including quotations and purchase orders) between two parties requires a reliable message transfer method and infrastructure. Conventional approaches to providing a reliable method and infrastructure include dedicated T1 lines, Virtual Area Networks (VANs) and Virtual Private Networks (VPNs). These approaches, however, are slow, cumbersome and/or expensive.

Furthermore, when inexpensive distributed communication networks, such as the Internet, are employed for the electronic transfer of messages, there is no guarantee that a message will not be lost or delayed for an extended period of time. Messages transferred via the Internet can be lost or delayed due to a variety of reasons, including on-going maintenance, improper configuration, or congestion of network components (e.g., routers, switches and firewalls) and the links between network components. Conventional methods for transferring messages often include provisions to re-send messages that are not received after an earlier attempt(s). However, these conventional methods typically re-use the same message path for each attempt, resulting in further delays and wasted bandwidth.

A method for providing the reliable and timely transfer of messages on a distributed communication network involves creating an overlay routed network and simultaneously transferring multiple copies of a message along alternate message paths by sending them through different intermediate overlay route processors (viz., hoops) (see U.S. patent application Ser. No. 09/740,521, filed Dec. 18, 2000, entitled “System for Handling Information and Information Transfers in a Computer Network,” which is hereby incorporated in full by reference).

There are typically multiple network components between the message source and the overlay route processor and similarly between the overlay route processor and the message destination. Selecting multiple overlay route processors does not guarantee, therefore, that the network paths do not share one or more intervening network components or network links.

A majority of the network path failures on the Internet are due to maintenance, mis-configuration, congestion or failures of these intervening network components and network links. Thus, even if multiple network paths are used, when they share a failed network component or network link, all of the multiple network paths will fail to deliver the message.

Still needed in the field, therefore, is a reliable and timely method for transferring messages on a distributed communication network. In addition, since the topology, congestion points and message paths of a distributed communication network can frequently change, the method should lend itself to dynamic utilization and be computationally efficient.

### BRIEF SUMMARY OF THE INVENTION

The present invention provides for methods to transfer messages on a distributed communication network in a reliable and timely manner. In addition, the methods, which are computationally efficient, can be utilized in a dynamic manner.

A method according to one exemplary embodiment of the present invention enables the reliable and timely transfer of messages in a distributed communication network that includes a message source coupled to a message destination by a plurality of message paths, each of which including at least one overlay route processor coupled to the message source by at least one network path. Furthermore, each network path includes intervening network components (e.g., intervening routers, intervening switches and/or intervening firewalls).

This exemplary embodiment includes a step of choosing a plurality of candidate overlay route processors (e.g., five candidate overlay route processors). Thereafter, the identity of the intervening network components in the network paths between the message source and each of the candidate overlay route processors is ascertained.

After the identity of the intervening network components is ascertained, at least two overlay route processors are chosen (i.e., “selected” overlay route processors) from the plurality of candidate overlay route processors based on minimizing the number of overlapping intervening network components in the network paths between the message source and the at least two selected overlay route processors. This selection is easily and efficiently accomplished by analyzing the ascertained identities of the intervening network components. A message is then transferred from the message source to the at least two selected overlay route processors along the network paths with a minimized number of overlapping intervening network components.

Since the message is transferred to at least two selected overlay route processors, unless there is a simultaneous intervening component failure on the network paths to each of the selected overlay route processors, the message will be delivered in a reliable and timely manner to at least one of the selected overlay route processors (and subsequently from that overlay route processor to the message destination). Furthermore, since the network paths used for the transfer have a minimal number of overlapping intervening network components, these network paths are optimally redundant in terms of reducing the probability of a simultaneous intervening network component failure on all of the network paths to the selected overlay route processors.

The ascertaining of intervening network components of a distributed communication network (e.g., the Internet) can be easily and efficiently implemented and conducted in a dynamic manner.

A better understanding of the features and advantages of the present invention will be obtained by reference to the following detailed description that sets forth illustrative embodiments, in which the principles of the invention are utilized, and the accompanying drawings.

### BRIEF DESCRIPTION OF THE DRAWINGS

FIG. 1 is a flow diagram illustrating a sequence of steps in a process according to one exemplary embodiment of the present invention; and

FIG. 2 is a simplified diagram illustrating a portion of a distributed communication network, in which a method in accordance with one exemplary embodiment of the present invention operates.

### DESCRIPTION EXEMPLARY EMBODIMENTS OF THE INVENTION

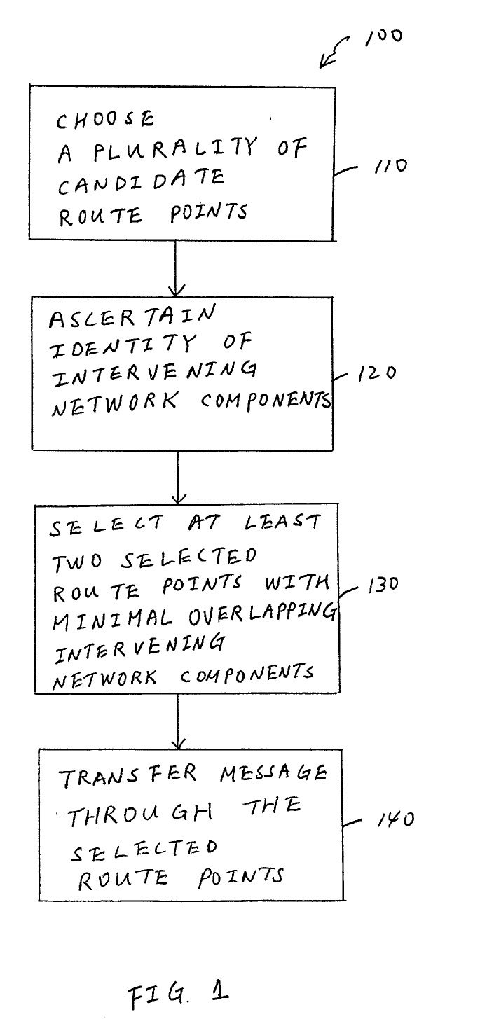

FIG. 1 is a flow diagram illustrating a sequence of steps in a process 100 for transferring messages in a distributed communication network (e.g., the Internet) in accordance with one exemplary embodiment of the present invention. The distributed communication network, in which the message is transferred, includes a message source coupled to a message destination by a plurality of message paths. Each of the message paths includes at least one overlay route processor. The overlay route processor is coupled to the message source by at least one network path that includes intervening network components (e.g., routers, switches and firewalls).

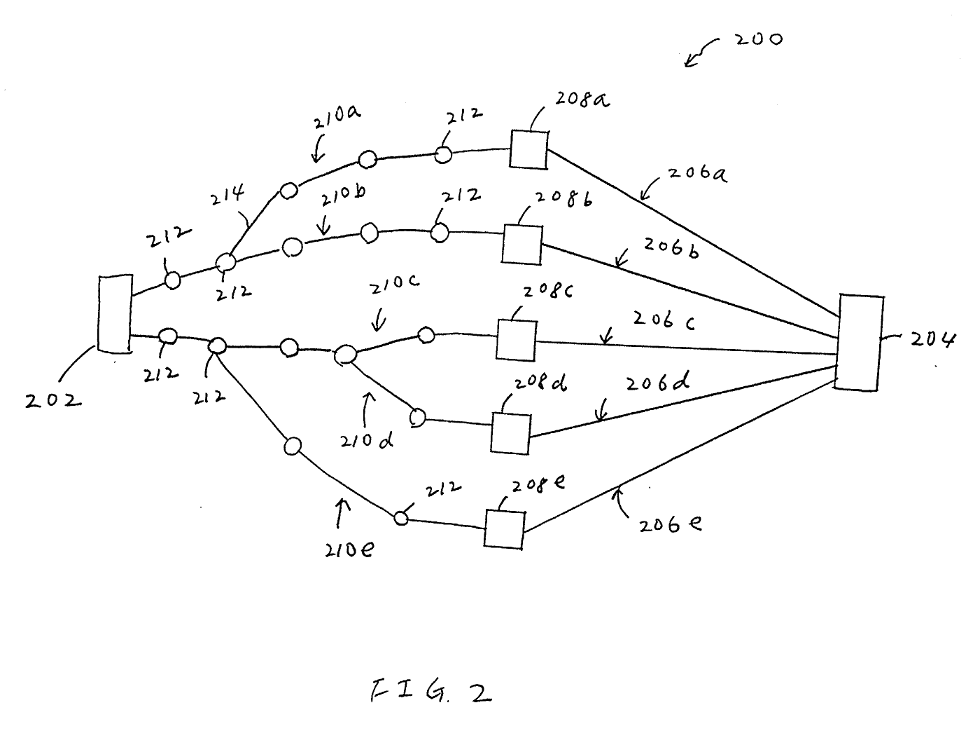

FIG. 2 is a simplified diagram of a portion of exemplary distributed communication network 200 in which process 100 operates to transfer a message. Distributed communication network 200 includes a message source 202, a message destination 204 and a plurality of message paths 206a-206e coupling message source 202 to message destination 204. For illustration and exemplary purposes only, five message paths are drawn in FIG. 2.

Each of message paths 206a-206e includes (and traverses) a overlay route processor 208 (viz., “hoop”), coupled to message source 202 by a network path, i.e., one of network paths 210a-210e. Each network path includes multiple intervening network components 212 (e.g., intervening routers, intervening switches, intervening firewalls depicted by a circular symbol) connected by links 214 (depicted as lines).

In the exemplary distributed communication network of FIG. 2, there are five message paths 206a-206e, five overlay route processors 208a-208e, and five network paths 210a-210e. The five network paths are not completely separate and distinct since they have overlapping intervening network components 212. For example, network paths 210a and 210b are overlapping with respect to the two intervening network components nearest message source 202. One of skill in the art will recognize that the portion of message paths 206a-206e between overlay route processors 208a-208e and message destination 204 can, for example, include intervening network components. However, for simplicity and the sake of discussion such intervening network components are not illustrated in FIG. 2.

Message source 202 and message destination 204 can be any suitable message source and destination known to one skilled in the art including, for example, a connector message source and a connector message destination through which business-to-business (B2B) Electronic Document Interchange (EDI) applications or users gain access to the message paths 206a-206e. The connectors can be software components that may populate a user or B2B/EDI application server. Such connectors are described in detail in aforementioned U.S. patent application Ser. No. 09/740,521, which has been incorporated in full by reference for all purposes. Furthermore, the overlay route processors ensure that communication from the message source to the message destination can be forced down separate and distinct network paths independent of direct Internet routing from the message source to the message destination.

Referring back to FIG. 1, process 100 includes choosing a plurality of candidate overlay route processors (e.g., a plurality of candidate overlay route processors from among overlay route processors of the distributed communication network), as set forth in step 110. The number of “chosen” candidate overlay route processors is typically five or more. Next, the identity (e.g., the IP-address) of the intervening network components in the network paths between the message source and each of the plurality of candidate overlay route processors is ascertained, as set forth in step 120.

For the sake of description, it is considered that overlay route processors 208a-208e of FIG. 2 were chosen as the candidate overlay route processors. In that circumstance, the identity of intervening network components 212 on network paths 210a-210e would be ascertained.

An exemplary procedure for ascertaining the identity of the intervening network components on a network path between a source and a destination entails use of a “traceroute” algorithm. The traceroute algorithm ascertains the identities of intervening network components by sending a series of User Datagram Protocol (UDP) or Internet Control Message Protocol (ICMP) packets from a source to a destination with a sequentially increasing hop-count (using the TTL field in the IP header). Each of the intervening network components decrements the hop-count by 1 and forwards the packet to the next intervening network component along a path to the destination. This continues until either the hop-count is no longer greater than zero or the destination is reached. When the hop count is no longer greater than zero, the intervening network component that is processing the UDP or ICMP packet drops the packet and transmits an ICMP failure message that contains the unique IP-address identity of that intervening network component back to the source. In this manner, the IP-address identity of each of the intervening network components on the network paths can be efficiently ascertained by the source.

The above traceroute procedure can be used to determine the identities of the intervening network components between the message source and each of the candidate overlay route processors.

This procedure for ascertaining the identities of the intervening network elements can be efficiently implemented via software and hardware (e.g., a memory for storing the ascertained identities) on a distributed communication network and can be run in a dynamic manner (e.g., every one hour) to continually ascertain the identities of frequently changing intervening network elements.

Next, as set forth in step 130 of FIG. 1, at least two overlay route processors are selected (i.e., “selected” overlay route processors) from the plurality of candidate overlay route processors be analyzing the ascertained identities of the intervening network elements. The two selected overlay route processors are chosen based on minimizing the number of overlapping intervening network components in the network paths between the message source and the at least two selected overlay route processors. The selection can be accomplished, for example, via software resident at the message source or other location of the distributed communication network.

Contemplating again the descriptive example wherein the selected overlay route processors were 208a-208e and the IP-address identities of intervening network components 212 were ascertained, either of overlay route processors 208a and 208b can be paired with any one of overlay route processors 208c-208e to provide two selected overlay route processors since those combinations include zero overlapping intervening network components. One skilled in the art will recognize, however, that circumstances involving other candidate overlay route processors can result in the selected overlay route processors having a minimized yet non-zero number of overlapping intervening network components.

If desired, the selection of selected overlay route processors can be based initially on minimizing the number of overlapping overlay route processors followed by either minimizing the number of intervening network components or maximizing the speed of the network paths (i.e., the speed between the message source and a overlay route processor). Considering once again the descriptive example, either of overlay route processors 208a and 208b can be paired with overlay route processor 208e to provide two selected overlay route processors since those combinations include zero overlapping intervening network components (as an initial criteria) and a minimum number of intervening network components (as a secondary criteria).

Subsequently, a message is transferred from the message source to (and subsequently through) the at least two selected overlay route processors along the network paths with a minimized number of overlapping intervening network components, as set forth in step 140 of FIG. 1. Since the same message is sent to at least two selected overlay route processors and the network paths to those selected overlay route processors have a minimized number of overlapping intervening network components (i..e., are optimally redundant), the probability of a simultaneous failures on both network paths is minimized.

Once apprised of the present disclosure, one of ordinary skill in the art will recognize that the present method can be utilized in a variety of distributed communication networks to improve the reliability and timeliness of message transfer. Such distributed networks include, but are not limited to, those described in aforementioned U.S. patent application Ser. No. 09/740,521.

It should be understood that various alternatives to the embodiments of the invention described herein may be employed in practicing the invention. It is intended that the following claims define the scope of the invention and that methods within the scope of these claims and their equivalents be covered thereby.

What is claimed is:

1. A method for transferring messages in a distributed communication network, wherein the distributed communication network includes a message source coupled to a message destination by a plurality of message paths, each of the message paths including at least one overlay route processor coupled to the message source by at least one network path, the network path including intervening network components, the method comprising:
choosing a plurality of candidate overlay route processors;
ascertaining the identity of the intervening network components in the network paths between the message source and each of the candidate overlay route processors;
selecting a plurality of selected overlay route processors from the candidate overlay route processors based on minimizing the number of overlapping intervening network components in the network paths between the message source and the selected overlay route processors by analyzing the ascertained identities of the intervening network components; and
transferring a message from the message source to the selected overlay route processors along the network paths with a minimized number of overlapping intervening network components.

2. The method of claim 1, further comprising during the selecting step, selecting a plurality of selected overlay route processors with zero overlapping intervening network components in the network paths between the message source and the selected overlay route processors.

3. The method of claim 1, wherein the choosing step includes choosing at least five candidate overlay route processors.

4. The method of claim 1, wherein the ascertaining step includes ascertaining the identity of intervening network components including intervening routers, intervening switches and intervening firewalls.

5. The method of claim 1, wherein the selecting of a plurality of selected overlay route processors from the plurality of candidate overlay route processors is based initially on minimizing the number of overlapping intervening network components in the network paths between the message source and the selected overlay route processors and then based on minimizing the number of intervening network components.

6. The method of claim 1, wherein the selecting of a plurality of selected overlay route processors from the plurality of candidate overlay route processors is based initially on minimizing the number of overlapping intervening network components in the network paths between the message source and the selected overlay route processors and then based on maximizing the transmission speed between the message source and the selected overlay route processors.

7. The method of claim 1, wherein the ascertaining step includes ascertaining the IP-address identity of the intervening network components.

8. The method of claim 7, wherein the ascertaining step uses a series of User Datagram Protocol (UDP) packets.

9. The method of claim 7, wherein the ascertaining step uses a series of Internet Control Message Protocol (ICMP) packets.

10. The method of claim 1, further comprising during the transferring step, transferring a message from a connector message source.

11. A method for transferring messages in a distributed communication network, wherein the distributed communication network includes a connector message source coupled to a connector message destination by a plurality of message paths, each of the message paths including at least one overlay route processor coupled to the message source by at least one network path, the network path including intervening network components, the method comprising:
choosing a plurality of candidate overlay route processors;
ascertaining the IP-address identity of the intervening network components in the network paths between the connector message source and each of the candidate overlay route processors;
selecting two selected overlay route processors from the plurality of candidate overlay route processors based on minimizing the number of overlapping intervening network components in the network paths between the connector message source and the two selected overlay route processors by analyzing the ascertained IP-address identities of the intervening network components; and
transferring a message from the connector message source to the two selected overlay route processors along the network paths with a minimized number of overlapping intervening network components.

12. The method of claim 11, further comprising during the selecting step, selecting two selected overlay route processors with zero overlapping intervening network components in the network paths between the connector message source and the two selected overlay route processors
